(19) United States
(12) Patent Application Publication
(10) Pub. No.: US 2011/0161950 A1
(43) Pub. Date: Jun. 30, 2011

(54) SOFTWARE OPERATION RESULTS MANAGEMENT SYSTEM, METHOD, AND PROGRAM

(75) Inventors: Shinichi TAKAIKE, Yokohama (JP); Yasuhiro YAMABE, Yokohama (JP)

(73) Assignee: FUJITSU LIMITED, Kawasaki-shi (JP)

(21) Appl. No.: 13/043,688

(22) Filed: Mar. 9, 2011

Related U.S. Application Data
(62) Division of application No. 12/005,197, filed on Dec. 26, 2007.

(30) Foreign Application Priority Data
Jan. 22, 2007 (JP) 2007-11656

(51) Int. Cl. G06F 9/44

(52) U.S. Cl. 717/171

(57) ABSTRACT

A software operation results management system has a server and a client connected to a network. The server manages operation results of prescribed software that is supplied from the server to the client and operates on the client. The server has software for storing the prescribed software; and monitoring software for monitoring operation results of the prescribed software on the client. The server transmits the prescribed software to the client in response to a request. The server requests operation results of the prescribed software from the client. The client apparatus has software requesting means for requesting the prescribed software from the server. Operation results acquired by the monitoring software are stored and transmitted to the server.

This is a Divisional of application Ser. No. 12/005,197, filed Dec. 26, 2007.

### FIELD OF THE INVENTION

The present invention relates to a software operation results management system, method, and program.

### SUMMARY OF THE INVENTION

A software operation results management system comprising a server and a client apparatus that are connected to each other via a network and in which the server manages operation results of prescribed software that is supplied from the server to the client apparatus and operates on the client apparatus, wherein the server comprises software storing means for storing the prescribed software; monitoring software storing means for storing monitoring software for monitoring operation results of the prescribed software on the client apparatus; transmitting means for transmitting the prescribed software stored in the software storing means and the monitoring software stored in the monitoring software storing means to the client apparatus in response a request for the prescribed software from the client apparatus; operation results requesting means for requesting the client apparatus to send operation results of the prescribed software; receiving means for receiving operation results of the prescribed software from the client apparatus; and operation results storing means for storing the operation results of the prescribed software received from the client apparatus; and the client apparatus comprises software requesting means for requesting the server to supply the prescribed software; receiving means for receiving the prescribed software and the monitoring software from the server; operation results storing means for storing the operation results of the prescribed software acquired by the monitoring software; and transmitting means for transmitting the operation results stored in the operation results storing means to the server.

### BRIEF DESCRIPTION OF THE DRAWINGS

FIG. 1 is a block diagram of a software operation results management system according to an embodiment of the present invention;

FIG. 2 shows a specific configuration of the software operation results management system according to the embodiment of the invention;

FIG. 3 shows a software information table according to the embodiment of the invention;

FIG. 4 shows a management information table according to the embodiment of the invention;

FIG. 5 shows a management information table 1 according to the embodiment of the invention;

FIG. 6 shows an upgrade policy table according to the embodiment of the invention;

FIG. 7 shows a first exemplary software use information table according to the embodiment of the invention;

FIG. 8 shows a second exemplary software use information table according to the embodiment of the invention;

FIG. 9 is a flowchart of a software operation results management process of a server according to the embodiment of the invention;

FIG. 10 is a flowchart of an operation results gathering process of each client apparatus according to the embodiment of the invention;

FIG. 11 is a flowchart of an update process of each client apparatus according to the embodiment of the invention;

FIG. 12 is a flowchart of a use states acquisition process of each client apparatus according to the embodiment of the invention;

FIG. 13 is a flowchart of an update process of each client apparatus according to the embodiment of the invention; and

FIG. 14 is a flowchart of an update sub-process of each client apparatus according to the embodiment of the invention.

### DESCRIPTION OF THE REFERENCE NUMERALS AND SIGNS

### Description of the Preferred Embodiments

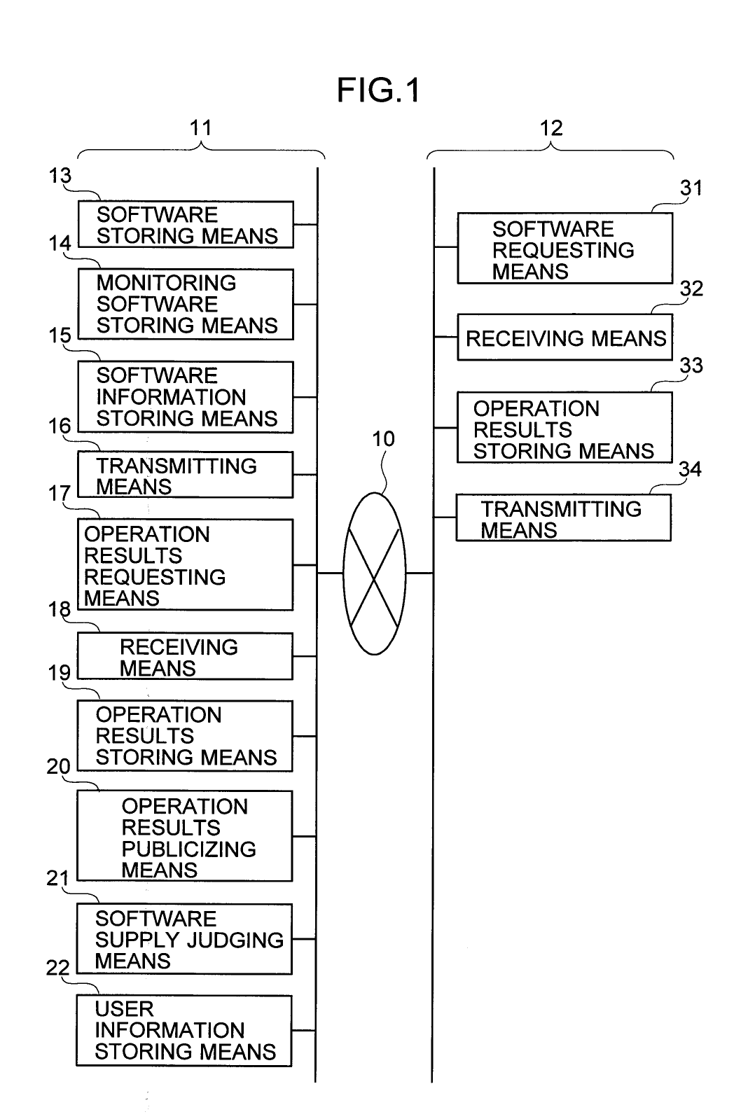

An embodiment of the present invention will be hereinafter described in detail with reference to FIGS. 1-14. The embodiment is just an example and the invention is not limited to it.

FIG. 1 shows a software operation results management system 1 according to the embodiment. The software operation results management system 1 is provided with a server 11 and plural client apparatus 12 that are connected to each other via a network 10.

In the software operation results management system 1, the server 11 manages operation results of prescribed software that is supplied from the server 11 to a client apparatus 12 and operates on the client apparatus 12.

The server 11 is equipped with a software storing means 13 for storing the prescribed software; a monitoring software storing means 14 for storing monitoring software for monitoring operation results of the prescribed software on a client apparatus 12; a software information storing means 15 for storing information relating to the prescribed software; a transmitting means 16 for transmitting, in response a request for the prescribed software from a client apparatus 12, the prescribed software stored in the software storing means 13 and the monitoring software stored in the monitoring software storing means 14 to the client apparatus 12 at the same time or separately; an operation results requesting means 17 for requesting the client apparatus 12 to send operation results of the prescribed software; a receiving means 18 for receiving operation results of the prescribed software from the client apparatus 12; an operation results storing means 19 for storing the operation results of the prescribed software received from the client apparatus 12; an operation results publicizing means 20 for publicizing, on the network 10, the operation results stored in the operation results storing means 19; a software supply judging means 21 for judging whether to supply the prescribed software to the client apparatus 12 on the basis of the operation results; and a management information storing means 22 for storing pieces of management information relating to users of the plural client apparatus 12.

Each of the pieces of management information is stored so as to correlate user identification information for identification of the associated user with criteria information indicating criteria for judging whether to allow the client apparatus 12 used by the user to update the prescribed software. The judgment criteria are set on the basis of installation results and operation results of the prescribed software.

Each of the plural client apparatus 12 is equipped with a software requesting means 31 for requesting the server 11 to supply the prescribed software; a receiving means 32 for receiving the prescribed software and the monitoring software from the server 11; an operation results storing means 33 for storing the operation results of the prescribed software acquired by the monitoring software; and a transmitting means for transmitting the operation results stored in the operation results storing means 33 to the server 11.

Each of the server 11 and the plural client apparatus 12 is a computer having a CPU, a memory, a hard disk drive, a communication interface, etc., and hence will not be described because its configuration and workings are well known.

The storing means 13, 14, 15, 19, and 22 of the server 11 are implemented by the hard disk drive, and the transmitting means 16 and the receiving means 18 of the sever 11 are implemented by the communication interface.

The receiving means 32 and the transmitting means 34 of each client apparatus 12 are implemented by the communication interface.

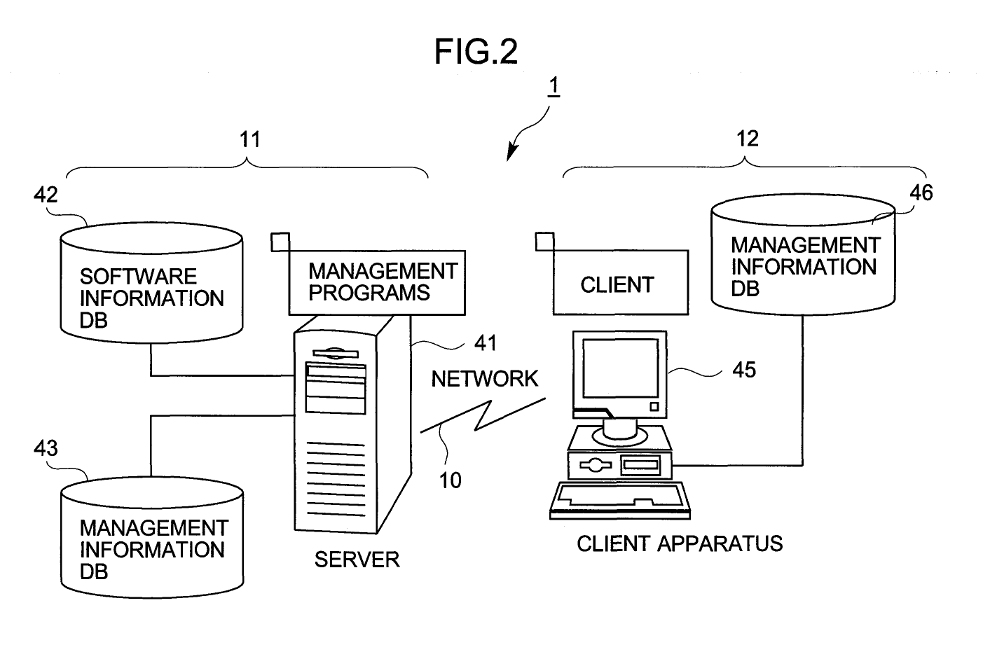

FIG. 2 shows a specific example of the software operation results management system 1. A terminal main body 41 such as a PC (personal computer), a software information DB (database) 42, a management information DB 43, etc. are provided in the server 11.

A terminal main body 45, a management information DB 46, etc. are provided in each client apparatus 12.

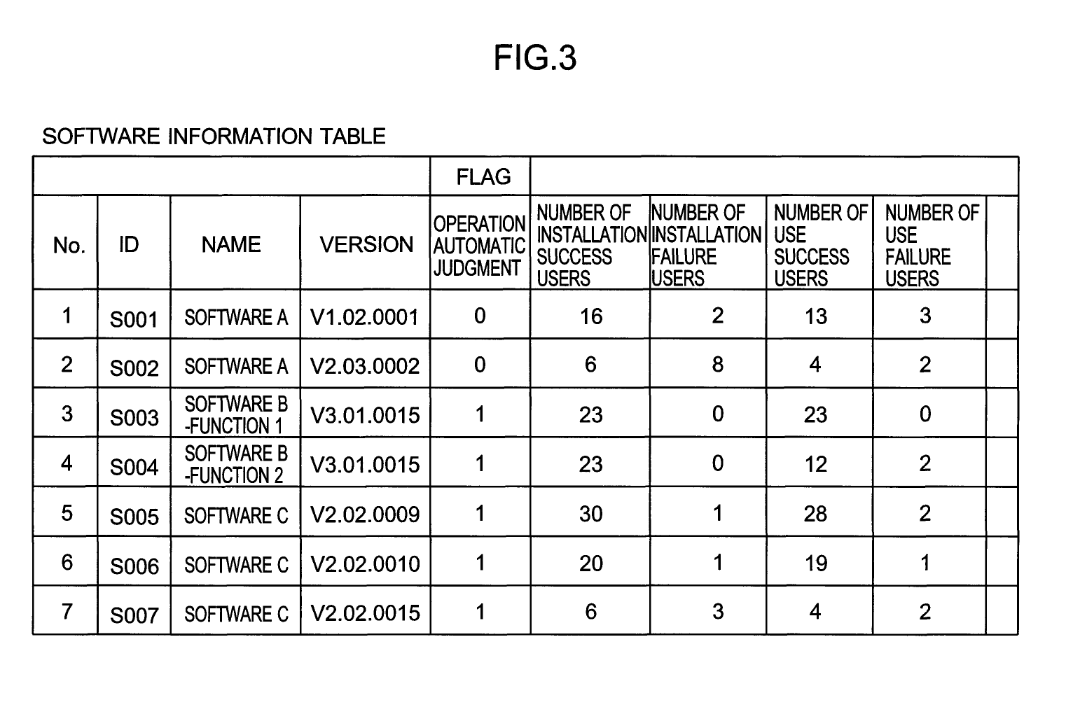

A software information table as shown in FIG. 3 is stored in the software information DB 42 of the server 11. The software information table has a No. (number) column, an ID (identification symbol) column, a column of names of plural pieces of software to be supplied to the client apparatus 12, a column of software versions, a column of operation automatic judgment flags each of which indicates whether the associated software itself can judge its operation results, a column of the numbers of installation success users each of which indicates the number of users (client apparatus) who succeeded in installation of the associated software, a column of the numbers of installation failure users each of which indicates the number of users who failed in installation of the associated software, a column of the numbers of use success users each of which indicates the number of users who experienced normal operation of the associated software, and a column of the numbers of use failure users each of which indicates the number of users who did not experience normal operation of the associated software.

For example, “S001,” “S002,” “S003,” . . . are written in the ID column as IDs for identification of pieces of software. “Software A,” “software B-function 1,” “software B-function 2,” “software C,” etc. are written in the name column as software names. “function 1” and “function 2” indicate that the two pieces of software bearing the same name have different functions.

Combinations of symbol “V” meaning a software version and numerals indicating a major upgrade and a minor upgrade are written in the version column.

For example, a version is represented by “Va.bb.cccc,” where the portion “a” indicates a version of major upgrade and portions “bb” and “cccc” indicate a version of minor upgrade. The portions “bb” and “cccc” are numerals.

For example, “V1.02.0001” is written in the version column of the No. 1 software which is software A (ID: S001). And “V2.03.0002” is written in the version column of the No. 2 software which is software A (ID: S002). It is therefore seen that the No. 2 software (software A) is a major upgrade version of the No. 1 software (software A).

“V2.02.0009” is written in the version column of No. 5 software which is software C (ID: S005). And “V2.02.0010” is written in the version column of the No. 6 software which is software C (ID: S006). It is therefore seen that the No. 6 software (software C; ID: S006) is a minor upgrade version of the No. 5 software (software C; ID: S005).

Number “1” is written in each operation automatic judgment flag column if the associated software itself can judge its operation results, and number “0” is written if not.

The number of installation success users, the number of installation failure users, the number of use success users, and the number of use failure users are written on the basis of information acquired by monitoring software on the client apparatus 12.

As mentioned above, the number of installation success users is the number of client apparatus 12 that succeeded in installation of the associated software. The number of installation failure users is the number of client apparatus 12 that failed in installation of the associated software.

As mentioned above, the number of use success users is the number of client apparatus 12 on which the associated software operated normally. The number of use failure users is the number of client apparatus 12 on which the associated software did not operate normally.

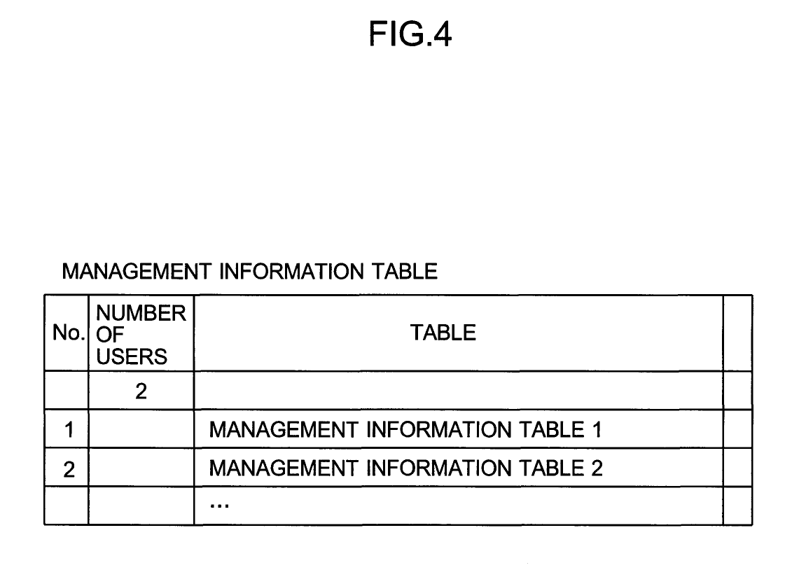

A management information table as shown in FIG. 4 is stored in the management information DB 43 shown in FIG. 2. The management information table is provided with a No. column, a number-of-users column, and a table column.

The number of client apparatus 12 that requested prescribed pieces of software is written in the number-of-users column.

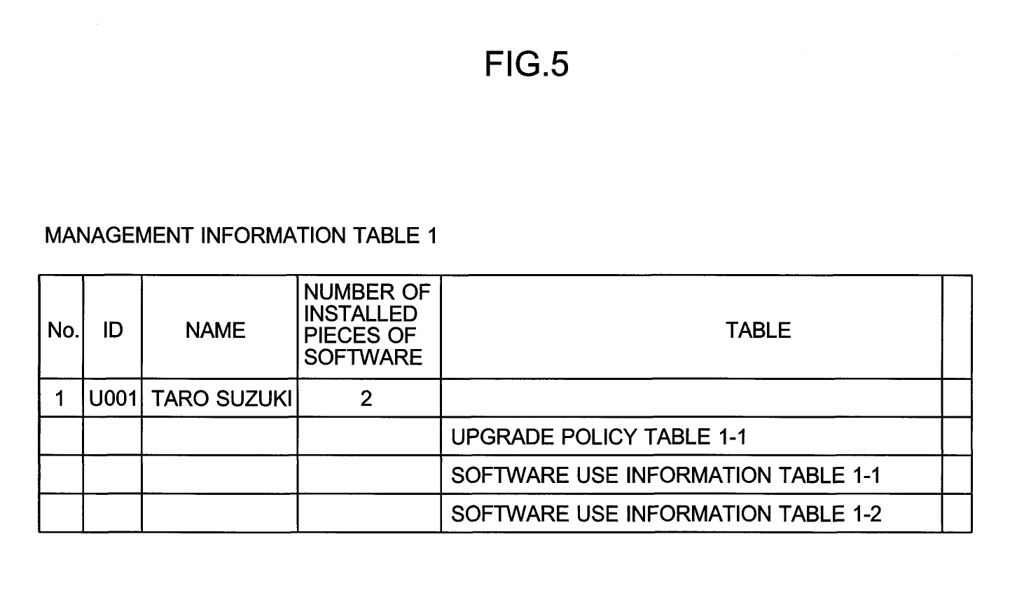

A management information table n (n: integer) is written in each table column. As shown in FIG. 5, each management information table n is provided with a No. column, a column of an ID for identification of a user (user identification information), a user name column, a column of the number of installed pieces of software, and a column of tables owned by the user. A user ID capable of identifying the user uniquely is written in the ID column.

An upgrade policy table and software use information tables n-m are written in each table column of the management information table n.

Various options are available for a method of communication with the server 11 that is performed in updating the management information table depending on the system configuration, the communication environment, the policy, etc. Examples of the communication method are a method that an alteration is reflected in the server 11 every time it occurs, a method with regular monitoring, and a method that the configuration of a client apparatus 12 is sent in response to a command from the server 11. Any of these methods may be employed.

The upgrade policy table n-m shown in FIG. 5 correlates the ID for identification of the user (user identification information) with criteria information indicating criteria for judging whether to allow the client apparatus 12 used by the user to upgrade prescribed pieces of software.

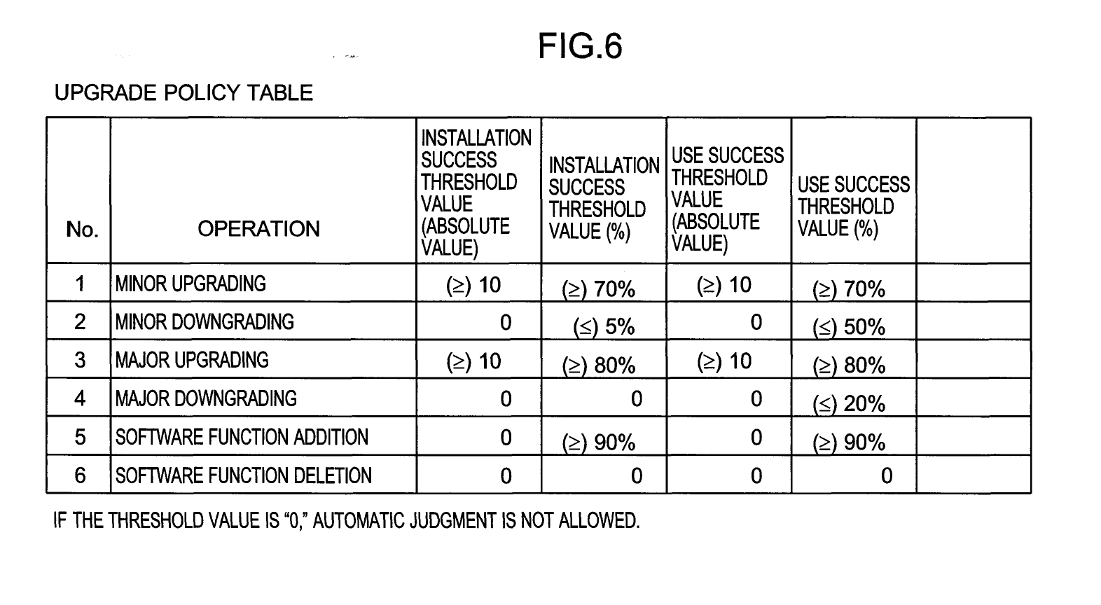

As shown in FIG. 6, the upgrade policy table n-m is provided with a No. column, an operation column, an installation success threshold value (absolute value) column, an installation success threshold value (%) column, a use success threshold value (absolute value) column, and a use success threshold value (%) column.

The operation column is provided with items “minor upgrading,” “minor downgrading,” “major upgrading,” “major downgrading,” “software function addition,” and “software function deletion.”

For example, the item “minor upgrading” is possible if the number of installation successes (absolute value) is larger than or equal to 10, the installation success rate (%) is larger than or equal to 70%, the number of successful uses (absolute value) is larger than or equal to 10, and the successful use rate (%) is larger than or equal to 70%.

That is, the No. 1 entry of the upgrade policy table indicates a policy that when a minor upgrade occurred in prescribed software, the client apparatus 12 concerned performs minor upgrading on the prescribed software if installation results and operation results of the minor upgrade in other client apparatus 12 satisfy the above criteria.

The No. 3 entry of the upgrade policy table is such that the operation is “major upgrading,” the number of installation successes (absolute value) is larger than or equal to 10, the installation success rate(%) is larger than or equal to 80%, the number of successful uses (absolute value) is larger than or equal to 10, and the successful use rate (%) is larger than or equal to 80%.

Therefore, the No. 3 entry of the upgrade policy table indicates a policy that when a major upgrade occurred in prescribed software, the client apparatus 12 concerned performs major upgrading on the prescribed software if the above criteria are satisfied.

In this example, each of threshold values “0” means that software itself is not allowed to perform automatic judgment for the corresponding operation.

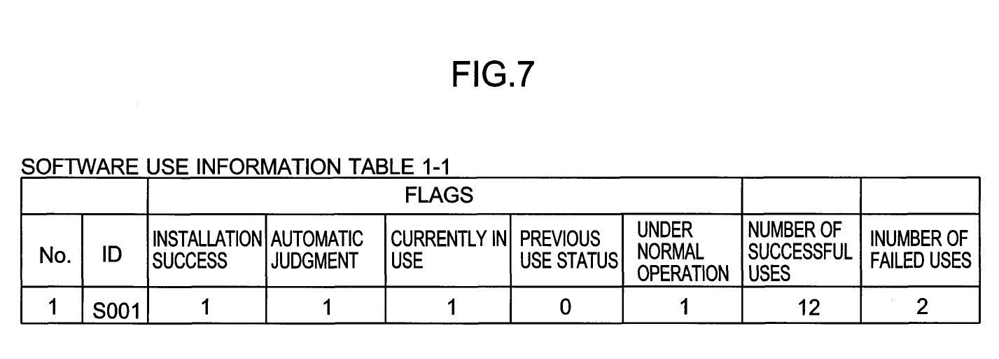

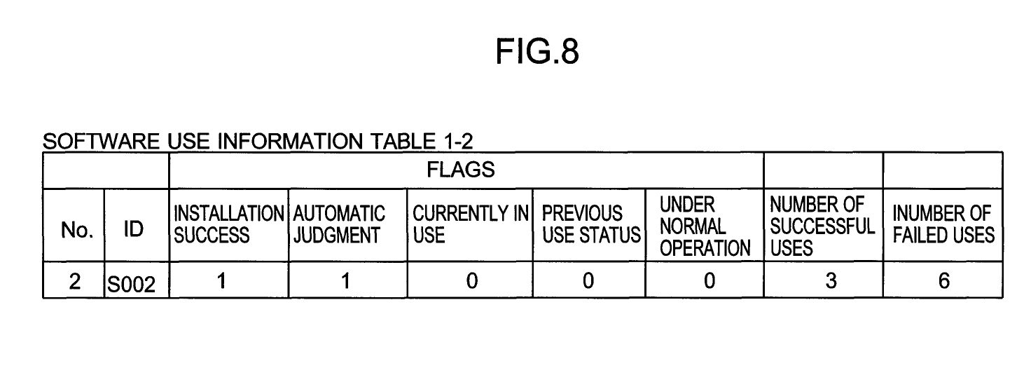

As shown in FIGS. 7 and 8, the software use information table n-m shown in FIG. 5 is provided with a No. column, an ID column, a flags column, a number-of-successful-uses column, and a number-of-failed-uses column. A software ID capable of identifying the software uniquely is written in the ID column.

The flag column is provided with an installation success column, an automatic judgment column, a currently-in-use column, a previous use status column, and an under-normal-operation column.

Number “1” is written in the installation success column if installation succeeded, and “0” is written in the installation success column if installation failed. Number “1” is written in the automatic judgment column if automatic judgment is possible, and “0” is written in the automatic judgment column if automatic judgment is impossible.

Number “1” is written in the currently-in-use column if the software is currently in use, and “0” is written in the currently-in-use column if the software is not in use currently. Number “1” is written in the previous use status column if the software was used last time, and “0” is written in the previous use status column if the software was not used last time.

Number “1” is written in the under-normal-operation column if the software is operating normally, and “0” is written in the under-normal-operation column if the software is not operating normally.

The number of successful uses is written in the number-of-successful-uses column, and the number of failed uses is written in the number-of-failed uses column.

For example, in the case of the No. 1 software (ID: S001) in a software use information table 1-1, “1” is written in each of the installation success column, the automatic judgment column, the currently-in-use column, and the under-normal-operation column. And number “0” is written in the previous use status column.

Therefore, the No. 1 software was installed successfully, automatic judgment is possible for it, it is currently in use, it was not used last time, and it is operating normally. Furthermore, the No. 1 software was used successfully 12 times and unsuccessfully two times.

Likewise, as shown in FIG. 8, it is seen from a software use information table 1-2 that the No. 2 software (ID: S002) was installed successfully, automatic judgment is possible for it, it is not in use currently, it was not used last time, it is not operating normally, and it was used successfully three times and unsuccessfully six times.

The software use information table is updated in the following manner. Where software that is compatible with the software operation results management system 1 is used, when a client apparatus 12 installs this software, a flag value “1” or “0” is written in the installation success column of the software use information table according to a result of the installation.

The software that is compatible with the software operation results management system 1 is software having a function of reporting an installation success, an installation failure, a normal operation, the number of successful uses, etc. to the system 1.

While software is operating on a client apparatus 12, its being in normal operation is detected if prescribed conditions are satisfied. Number “0” or “1” is written in the under-normal-operation column of the software use information table according to a result of the detection. Number “0” is written in the automatic judgment column if it is difficult to detect that the software is operating normally.

Whether or not software is operating normally on a client apparatus 12 is judged by judging, for example, whether the client apparatus 12 does not detect a self-error and whether loops are executed with prescribed timing.

In the case of software that is not compatible with the software operation results management system 1 but is a subject of update, no number is written automatically in the installation success column. Therefore, dedicated software refreshes the software use information table to a latest state in response to an explicit manipulation of a client apparatus 12 (e.g., an input from a user). Alternatively, a latest state is always detected by regular monitoring.

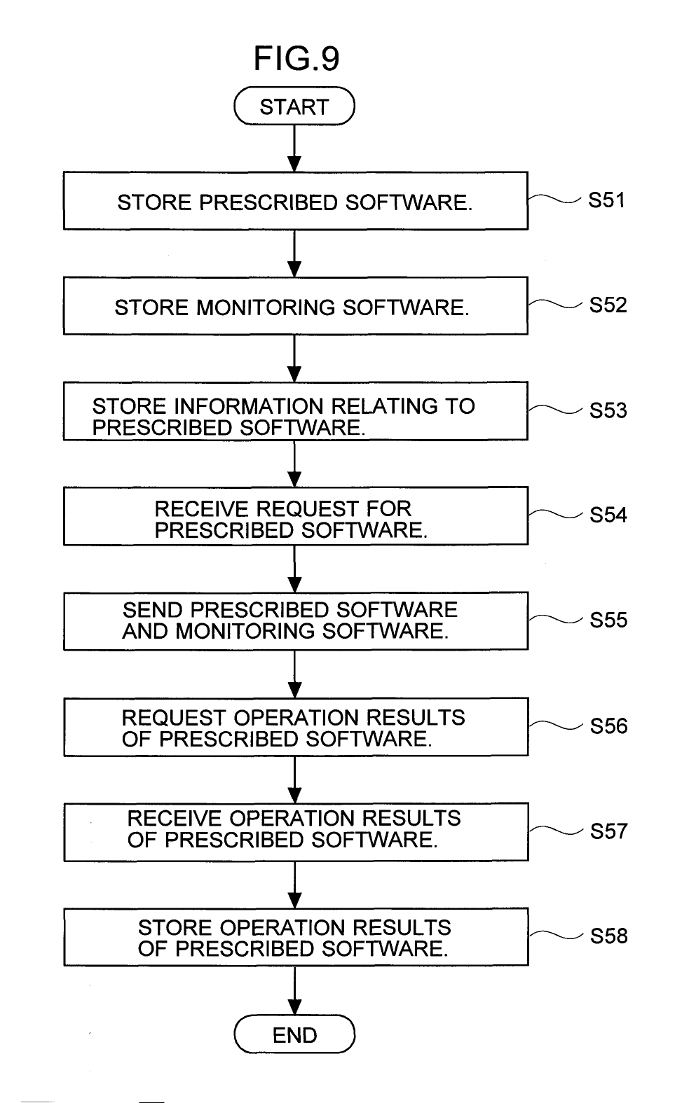

FIG. 9 is a flowchart of a software operation results management process of the server 11. First, at step S51, the server 11 stores prescribed software in the software storing means 13 (see FIG. 1). At step S52, the server 11 stores monitoring software in the monitoring software storing means 14.

At step S53, the server 11 stores information relating to the prescribed software in the software information storing means 15. At step S54, the server 11 receives a request for the prescribed software from a client apparatus 12. At step S55, the server 11 sends the prescribed software and the monitoring software to the client apparatus 12.

At step S56, the server 11 requests the client apparatus 12 to send operation results of the prescribed software. At step S57, the server 11 receives operation results of the prescribed software from the client apparatus 12. At step S58, the server 11 stores the operation results of the prescribed software in the operation results storing means 19.

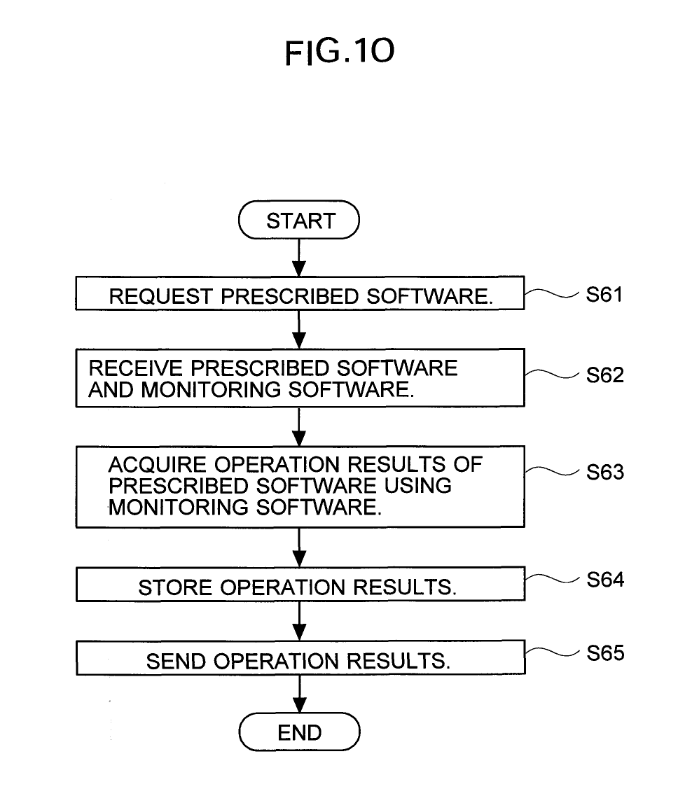

FIG. 10 is a flowchart showing the procedure of an operation results gathering process of each client apparatus 12.

First, at step S61, the client apparatus 12 requests the server 11 to send prescribed software. At step S62, the client apparatus 12 receives the prescribed software and monitoring software from the server 11.

At step S63, the client apparatus 12 gathers operation results of the prescribed software using the monitoring software. At step S64, the client apparatus 12 stores the operation results of the prescribed software in the operation results storing means 33. At step S65, the client apparatus 12 sends the operation results of the prescribed software to the server 11.

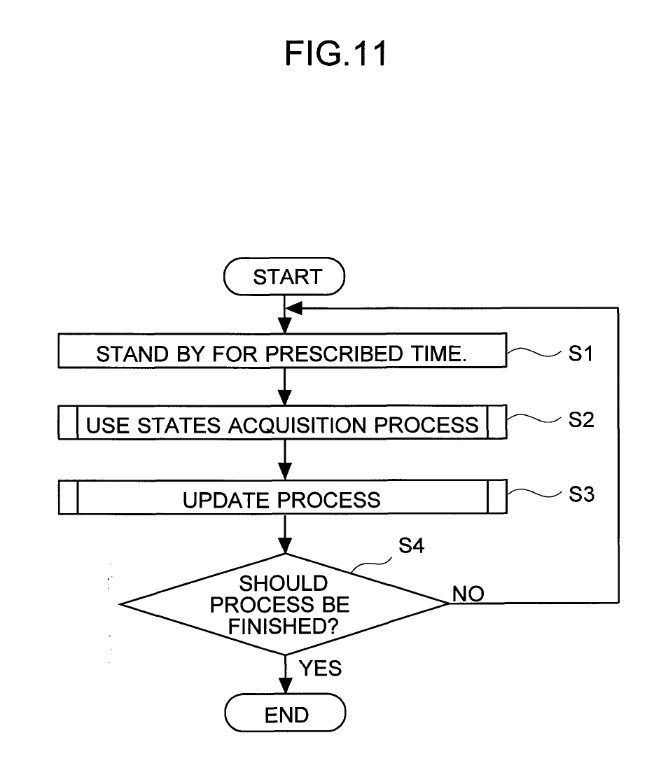

FIG. 11 is a flowchart showing a procedure for acquiring use states (operation results) of prescribed software using monitoring software that is installed in a client apparatus 12.

First, at step S1, the client apparatus 12 stands by for a prescribed time to lower the load of the terminal. At step S2, the client apparatus 12 executes a use states acquisition process for the prescribed software.

At step S3, the client apparatus 12 executes a process of updating the prescribed software. At step S4, the client apparatus 12 judges whether to finish this software use states acquiring process when a shutdown manipulation, for example, is made.

If it is judged at step S4 that the process should be finished, the client apparatus 12 finishes the process. If it is judged at step S4 that the process need not be finished, the client apparatus 12 returns to step S1.

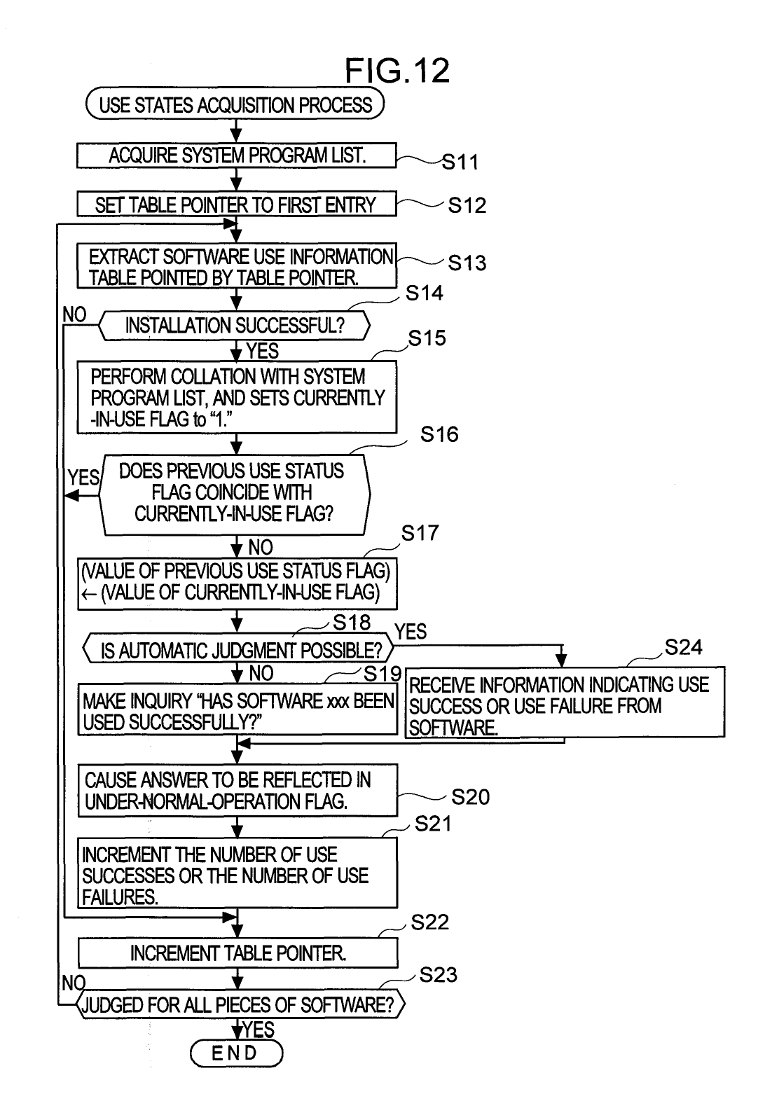

FIG. 12 is a flowchart of the above-mentioned use states acquisition process (S2 in FIG. 11). First, at step S11, the client apparatus 12 acquires its system program list. For example, this can be done by using a function that is attached to the OS (operating system).

At step S12, the client apparatus 12 points, with a table pointer, the first software use information table 1-1 in the management information table (see FIG. 5). At step S13, the client apparatus 12 extracts the pointed software use information table 1-1.

At step S14, the client apparatus 12 judges, on the basis of the software use information table 1-1 (see FIG. 7), whether or not the software was installed successfully. If it is judged at step S14 that the installation succeeded, at step S15 the client apparatus 12 performs collation with the program list that was acquired at step S11 and writes “1” in the currently-in-use column of the software use information table 1-1.

At step S16, the client apparatus 12 judges whether or not the flag of the previous-use-status column coincides with the flag of the currently-in-use column. If it is judged that they do not coincide with each other, at step S17 the flag value of the currently-in-use column is set as that of the previous-use-status flag.

At step S18, the client apparatus 12 judges, on the basis of the software use information table 1-1, whether the value of the automatic judgment column is “1” (automatic judgment is possible) or “0” (automatic judgment is impossible). If the value of the automatic judgment column is “0” (automatic judgment is impossible), at step S19 the client apparatus 12 displays a message for inquiring of the user whether or not the software concerned has been used successfully.

At step S20, the client apparatus 12 causes an answer to the inquiry to be reflected in the under-normal-operation column of the software use information table 1-1. For example, if the answer to the inquiry message of step S19 is “the software has been used successfully,” the client apparatus 12 writes “1” in the under-normal-operation column. If the answer is “the software has not been used successfully,” the client apparatus 12 writes “0” in the under-normal-operation column.

At step S21, the client apparatus 12 increments the value of the number-of-use-successes column or the number-of-use-failures column of the software use information table 1-1 by “1” according to the result of reflection at step S20.

At step S22, the client apparatus 12 causes the table pointer, which currently points the first software use information table 1-1 of the management information table, to point the next software use information table 1-2.

At step S23, the client apparatus 12 judges whether or not all the judgment steps S14, S16, and S18 have been executed for all the software use information tables of the management information table.

If judging at step S23 that all the judgment steps have been executed for all the software use information tables, the client apparatus 12 finishes the use states acquisition process. If judging at step S23 that all the judgment steps have not been executed yet for all the software use information tables, the client apparatus 12 returns to step S13.

If judging at step S14 that the installation failed, the client apparatus 12 moves to step S22. If judging at step S16 that the flag of the previous-use-status column coincides with the flag of the currently-in-use column, the client apparatus 12 moves to step S22.

If judging at step S18 that “1” is written in the automatic judgment column, the client apparatus 12 receives information indicating a use success or a use failure from the software concerned at step S24 and then moves to step S20.

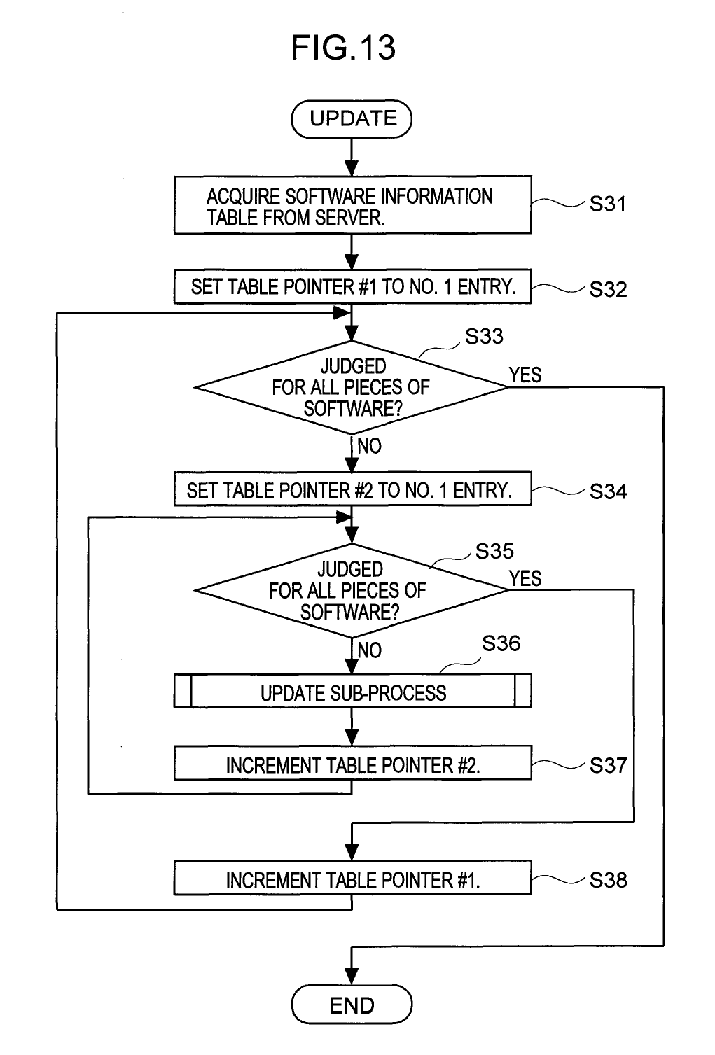

FIG. 13 shows the procedure of the above-mentioned update process (S3 in FIG. 11) of the client apparatus 12. First, at step S31, the client apparatus 12 acquires the software information table (see FIG. 3) from the server 11.

In this embodiment, the client apparatus 12 acquires the entire software information table from the server 11 and judges whether to update the software information table by itself. Another embodiment is possible in which the client apparatus 12 sends client information to the server 11 and the server 11 judges whether to update the software information table.

After executing step S31, at step S32 the client apparatus 12 sets a table pointer to the No. 1 entry of the acquired software information table. At step S33, the client apparatus 12 judges whether or not the above-described judgment steps S14, S16, and S18 have been executed for all pieces of software listed on the software information table.

If judging that the judgment steps S14, S16, and S18 have not been executed for all pieces of software, at step S34 the client apparatus 12 sets the table pointer to the No. 2 entry of the software information table.

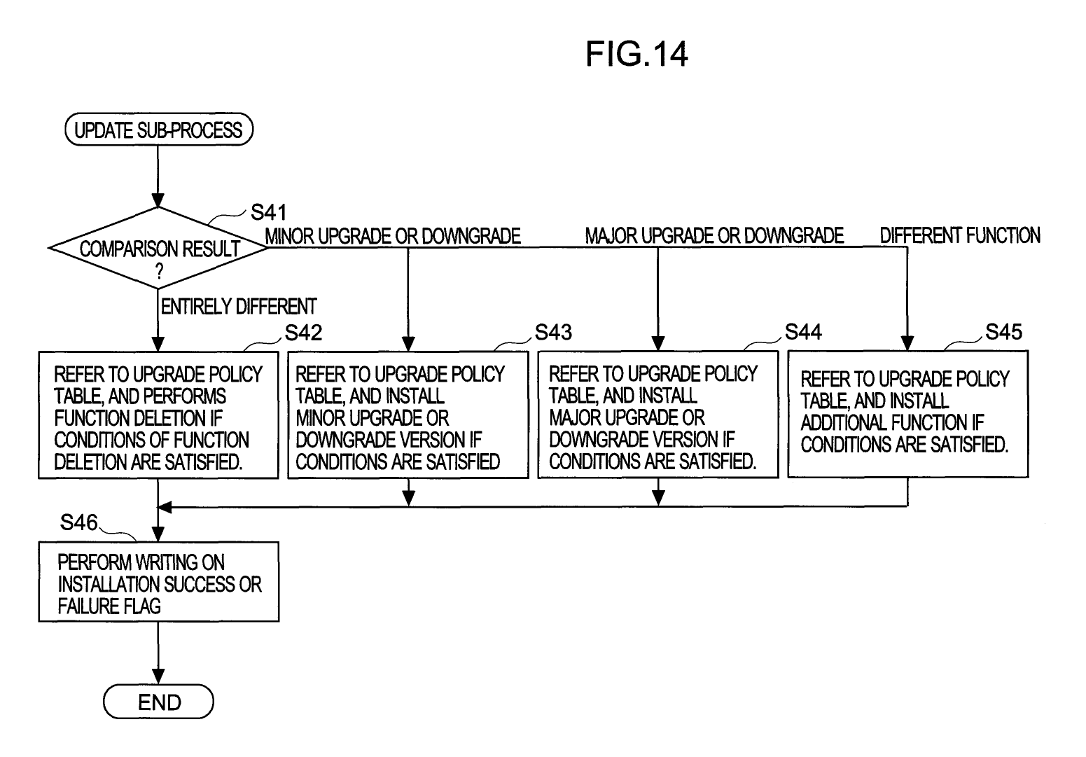

At step S35, the client apparatus 12 judges whether or not the judgment steps S14, S16, and S18 have been executed for all pieces of software listed on the software information table. If judging that the judgment steps S14, S16, and S18 have not been executed for all pieces of software, at step S36 the client apparatus 12 executes an update sub-process (see FIG. 14).

At step S37, the client apparatus 12 sets the table pointer to the next entry of the software information table. Then, the client apparatus 12 returns to step S35.

If judging at step S33 that the judgment steps S14, S16, and S18 have been executed for all pieces of software, the client apparatus 12 finishes the process.

If judging at step S35 that the judgment steps S14, S16, and S18 have been executed for all pieces of software, the client apparatus 12 moves the table pointer of the software information table downward by one entry at step S38. Then, the client apparatus 12 returns to step S33.

FIG. 14 shows the procedure of the above-mentioned update sub-process (S36). In the update sub-process, the first entry of the software information table (see FIG. 3) is compared with the first entry of the management information table (see FIG. 4) and steps described below are executed.

First, at step S41, the client apparatus 12 compares prescribed software installed in itself with prescribed software supplied from the server 11 and judges whether or not the two pieces of software are entirely different from each other, whether or not there exists a minor upgrade or downgrade, whether or not there exists a major upgrade or downgrade, or whether or not there exists a different function.

If judging at step S41 that the two pieces of software are entirely different from each other, at step S42 the client apparatus 12 refers to the upgrade policy table (see FIG. 6) and performs function deletion if the conditions of software function deletion are satisfied. At step S46, the client apparatus 12 performs writing on the installation success or failure flag for the software.

If judging at step S41 that there exists a minor upgrade or downgrade, at step S43 the client apparatus 12 refers to the upgrade policy table and installs a minor upgrade or downgrade version if the conditions are satisfied. If the installation succeeds, at step S46 the client apparatus 12 performs writing on the installation success flag.

If judging at step S41 that there exists a major upgrade or downgrade, at step S44 the client apparatus 12 refers to the upgrade policy table and installs a major upgrade or downgrade version if the conditions are satisfied. If the installation succeeds, at step S46 the client apparatus 12 performs writing on the installation success flag.

If judging at step S41 that there exists a different function, at step S45 the client apparatus 12 refers to the upgrade policy table and installs an additional function if the conditions are satisfied. If the installation succeeds, at step S46 the client apparatus 12 performs writing on the installation success flag.

### <Judgment as to Whether Minor Upgrade, Major Upgrade, or the Like Exists>

In this embodiment, to simplify each table, software is identified only by its name. Likewise, a function is identified according to a naming rule using two names (in the case of software A-function 1, for example, the portion on the right of the hyphen is used). However, a more sophisticated method may be employed in which the identity of software is managed hierarchically by giving IDs to genres, components, functions, etc.

As for software for which coincidence is found at the above-described step S41, the client apparatus 12 judges a difference in minor version or major version using the version portion. If the version is represented by “Va.bb.cccc,” the client apparatus 12 judges that the portion “a” represents a major version and the portions “bb” and “cccc” represent a minor version.

### <Example of Reference to Upgrade Policy Table>

For example, if software that is of a higher rank in terms of the major version exists in the server 11, the client apparatus 12 refers to the No. 3 entry of the upgrade policy table (see FIG. 6).

The client apparatus 12 judges whether to perform major upgrading by collating, with necessary calculations, the installation success flag, the number of successful uses, and the number of failed uses that are extracted from the software use information table n-m (see FIGS. 7 and 8) with the installation success threshold value (absolute value) and the use success threshold value (%) of the No. 3 entry.

As described above, in the software operation results management system 1 according to the invention, when a client apparatus 12 requests the server 11 to send prescribed software, the server 11 sends the prescribed software and monitoring software for monitoring operation results of the prescribed software to the client apparatus 12.

When the prescribed software and the monitoring software are installed in the client apparatus 12, installation results and operation results of the prescribed software are gathered automatically by the monitoring software on the client apparatus 12 and are then stored. The acquired installation results and operation results are sent to the server 11.

In the above manner, the server 11 can acquire operation results etc. of prescribed software in the plural client apparatus 12.

The server 11 can publicize acquired operation results etc. of prescribed software on the network 10. In this case, a user who is going to use the prescribed software can refer to the software use information table and hence can use it as a judgment material to be taken into consideration in using the prescribed software.

The server 11 is provided with the software supply judging means 21 which judges whether to supply prescribed software to a client apparatus 12 on the basis of monitoring results of monitoring software on the client apparatus 12.

This makes it possible to prevent the server 11 from supplying software that will very likely cause an installation failure, software that will operate in an unstable manner, or like software to the client apparatus 12.

Since the upgrade policy table of the management information table includes criteria for judging whether to allow a client apparatus 12 to update prescribed software, the client apparatus 12 can update the prescribed software automatically.

What is claimed is:

1. A computer comprising:
means for receiving results of installing an updating software, operation of an updated software obtained by said installing, or both of said installing and said operation, said results being monitored by other computers when said other computers install said updating software;
means for judging whether said received results comply with a predetermined condition; and
means for installing said updating software in said computer when said condition is satisfied.

2. A method for installing updating software, said method comprising:
receiving results of installing an updating software, operation of an updated software obtained by said installing, or both of said installing and said operation, said results being monitored by other computers when said other computers install said updating software;
judging whether said received results comply with a predetermined condition; and
installing, by a computer, said updating software in said computer when said condition is satisfied.

3. A computer comprising:
a communication interface configured to receive results of installing an updating software, operation of an updated software obtained by said installing, or both of said installing and said operation, said results being monitored by other computers when said other computers install said updating software,
wherein said computer configured to judging whether said received results comply with a predetermined condition and to install said updating software in said computer when said condition is satisfied.
